(19) United States
(12) Patent Application Publication
(10) Pub. No.: US 2013/0146809 A1
(43) Pub. Date: Jun. 13, 2013

(54) CONTINUOUS MANUFACTURING METHOD FOR ELECTRODE MATERIAL

(71) Applicants: Hirofumi Takemoto, Ube-shi (JP); Kazuo Hashimoto, Ube-shi (JP); Atsuo Hitaka, Ube-shi (JP)

(72) Inventors: Hirofumi Takemoto, Ube-shi (JP); Kazuo Hashimoto, Ube-shi (JP); Atsuo Hitaka, Ube-shi (JP)

(73) Assignee: UBE INDUSTRIES, LTD., Ube-shi, Yamaguchi (JP)

(21) Appl. No.: 13/818,778

(22) PCT Filed: Aug. 25, 2011
(86) PCT No.: PCT/JP2011/069208

§ 371 Date: Feb. 25, 2013

(30) Foreign Application Priority Data
Aug. 26, 2010 (JP) 2010-189949

(51) Int. Cl. H01M 4/04

(52) U.S. Cl. CPC H01M 4/0471
USPC 252/182.1

(57) ABSTRACT

The present invention relates to a process for continuously manufacturing a lithium secondary battery electrode material comprising: dispersing a transition metal compound in a solution of a lithium compound in an aqueous medium to give a mixture; and charging the mixture in a rotatory cylinder and drying and calcining the mixture, wherein the mixture is stirred by an impeller mounted in the interior of the rotatory cylinder.

### TECHNICAL FIELD

The present invention relates to a continuous process for manufacturing a lithium transition metal complex oxide active material as an electrode material used for a cathode or anode of a lithium secondary battery, utilizing intercalation and deintercalation of lithium.

### BACKGROUND ART

Recently, as electronic devices have been size-reduced, improved in performance and improved in portability, rechargeable secondary batteries such as a Ni-MH alkali storage battery and a lithium secondary battery have been practically and extensively used. In particular, the use of a lightweight nonaqueous electrolyte lithium secondary battery with a high energy density is expected to be applied not only to conventional small information-communications devices such as cell phones and laptop computers, but also to a large battery for industrial applications such as automobiles which are required to have high-output properties. It is, therefore, needed to develop an efficient process for manufacturing such electrode materials.

Typical known examples of a cathode material for a lithium secondary battery include lithium cobalt oxide (LiCoO₂), lithium nickel cobalt oxide (LiNi_{0.85}Co_{0.15}O₂), lithium nickel cobalt manganese oxide (LiCo_{1/3}Ni_{1/3}Mn_{1/3}O₂), lithium manganese oxide (LiMn₂O₄) and examples of an anode material include lithium titanium oxide (Li₄Ti₅O₁₂). These are conventionally produced by a static process comprising dry-blending and pulverizing a transition metal compound as precursor and a lithium compound, filling a sagger with the mixture and calcining the mixture in the atmosphere or under a controlled atmosphere. In a process where the mixture is calcined in a static state, a precursor is insufficiently in contact with a lithium compound, leading to elimination of gases generated by decomposition of the precursor (water, carbon dioxide) and inadequate supply of an atmosphere gas into the mixture, insufficient heat transfer and thus filling amount is limited. It leads to calcination at an elevated temperature for a prolonged period, causing problems in quality and productivity.

To solve the above problems, there have been, for example, disclosed a process wherein calcination is conducted while forcedly feeding a supply gas to a packed layer of mixed powder to synthesize a homogeneous cathode material with a high capacity (Patent Reference No. 1), a process wherein a transition metal compound and a lithium compound are pulverized in an aqueous medium and the resulting solid-liquid mixture is spray-dried to give a homogeneously-blended powdery solid, which is then calcined (Patent Reference No. 2), a process wherein a powder mixture of water-containing fine particle powder of a cobalt oxide and a lithium compound is compression-molded and the resulting molded article is calcined for a short period (2 to 10 hours) under an oxygen-containing gas atmosphere, which is then pulverized (Patent Reference No. 3), a process wherein a mixed powder is charged in a rotary furnace such as a rotary kiln or a retort kiln and evenly calcined by heating while the packed layer is rolled (flowed) (Patent Reference Nos. 4 and 5), and, as a continuous manufacturing process, a process wherein an aqueous solution of a mixture of a water-soluble lithium compound and a precursor compound is thinly (1 mm or less) sprayed and adhered on an endless belt and sequentially calcined to continuously conduct a reaction/synthesis (Patent Reference No. 6).

However, these processes described in the prior art documents have problems in terms of productivity such as increase in steps, complicated apparatus structures and reduction in an operation efficiency. For example, the disclosed process using heating and calcination by a rotary furnace has a problem that during a long-term operation, a mixture adheres to and increases on the inner wall surface of the furnace, hampering even heating, and in some cases, causing blockage of the furnace and thus failure to collect an electrode material.

### PRIOR ART REFERENCES

### Patent References

Patent Reference No. 1: Japanese Laid-Open patent publication No. 1993-62678.

Patent Reference No. 2: Japanese Laid-Open patent publication No. 2009-277667.

Patent Reference No. 3: Japanese patent publication No. 4058797.

Patent Reference No. 4: Japanese Laid-Open patent publication No. 1994-171947.

Patent Reference No. 5: Japanese patent publication No. 3446390.

Patent Reference No. 6: Japanese Laid-Open patent publication No. 1998-297925.

### PROBLEM TO BE SOLVED BY THE INVENTION

To solve the problems described above, an objective of the present invention is to provide a process capable of continuously producing a homogeneous electrode material with stable quality by brief calcination for a long time.

### MEANS FOR SOLVING PROBLEM

The present inventors have found that a homogeneous electrode material with stable quality can be continuously produced by charging a mixture of a transition metal compound and a lithium compound in a rotatory cylinder equipped with an impeller for improving reactivity of the transition metal compound and the lithium compound and homogeneously stirring and mixing the mixture by the impeller mounted in the interior of the rotatory cylinder while drying and calcining the mixture under controlling adhesion and increase of the mixture on the inner surface of the cylinder, to achieve the present invention. Specifically, the present invention relates to the following items.

[1] A process for continuously manufacturing a lithium secondary battery electrode material comprising:
dispersing a transition metal compound in a solution of a lithium compound in an aqueous medium to give a mixture; and
charging the mixture in a rotatory cylinder and drying and calcining the mixture;
wherein the mixture is stirred by an impeller mounted in the interior of the rotatory cylinder.

[2] The manufacturing process as described in [1], wherein the impeller mounted in the rotatory cylinder comprises a plurality of blades mounted such that the blades are to be in contact with the inner surface of the rotatory cylinder and rotation of the rotatory cylinder causes rotation of the impeller, allowing the mixture to be stirred up, flowed and/or floated.

[3] The manufacturing process as described in [1] or [2], wherein in the drying and calcining, the mixture is heated at a temperature of 400° C. or more and less than 1100° C. and a heating time is 2 min or more and less than 60 min.

[4] The manufacturing process as described in any one of [1] to [3], wherein the rotatory cylinder is oblique to a horizontal plane at an angle of 1° or more and 10° or less.

[5] The manufacturing process as described in any one of [1] to [4], wherein a rotation rate of the rotatory cylinder is 5 rpm or more and 40 rpm or less.

[6] The manufacturing process as described in any one of [1] to [5], wherein the rotatory cylinder and the impeller are made of an alloy containing 10% by weight or more of nickel as a main component.

[7] The manufacturing process as described in any one of [1] to [6], wherein the transition metal compound is selected from the group consisting of hydroxides, oxides, carbonate and oxalates of one or more transition metals.

[8] The manufacturing process as described in any one of [1] to [7], wherein a solid concentration in the mixture is 10% by weight or more.

[9] The manufacturing process as described in any one of [1] to [8], wherein the mixture comprises a lower alcohol compound or an aliphatic ketone compound.

[10] A lithium secondary battery electrode material produced by the manufacturing process as described in any one of [1] to [9], having a layered structure, a spinel structure or an olivine structure.

### EFFECT OF THE INVENTION

In accordance with the present invention, a mixture of a transition metal compound and a lithium compound charged in a rotatory cylinder can be homogeneously stirred/mixed by an impeller mounted in the interior of the rotatory cylinder, and can be dried and calcined under inhibiting adhesion and increase of the mixture on the inner surface of the cylinder. It, therefore, allows an electrode material with stable quality to be efficiently and continuously produced in a short period.

### MODE FOR CARRYING OUT THE INVENTION

### <Continuous Manufacturing Process for an Electrode Material>

In one aspect, a process for manufacturing a lithium secondary battery electrode material of the present invention comprises:

(Step 1) dispersing a transition metal compound in a solution of a lithium compound in an aqueous medium to give a mixture; and

(Step 2) charging the mixture in a rotatory cylinder and stirring by an impeller mounted in the interior of the rotatory cylinder to dry and calcine the mixture.

### <Transition Metal Compound>

Examples of a transition metal compound used in (Step 1) include, but not limited to, hydroxides, oxides, carbonates and oxalates of a transition metal having an average primary particle size of 0.1 μm or more and 15 μm or less. In the present invention, a transition metal compound includes a complex of two or more transition metal compounds. Examples of a hydroxide include Co(OH)₂, Ni(OH)₂, Mn(OH)₂, NiOOH, CoOOH, FeOOH, TiO(OH)₂ and Ti(OH)₄, and complex hydroxides thereof (for example, Ni_{1/3}Co_{1/3}Mn_{1/3}(OH)₂, Ni_{0.85}Co_{0.15}(OH)₂). Examples of an oxide include CO₃O₄, NiO, Mn₂O₃, MnO₂, Fe₃O₄, Fe₂O₃, TiO₂ and complex oxides thereof. Examples of a carbonate include NiCO₃, CoCO₃, MnCO₃, basic carbonates (for example, Ni_{0.85}Co_{0.15}CO₃), and complex (basic) carbonates thereof. Examples of an oxalate include FeC₂O₄, CoC₂O₄, NiC₂O₄, MnC₂O₄, and complex oxalates thereof (for example, Ni_{0.85}Co_{0.15}C₂O₄).

### <Lithium Compound>

Examples of a lithium compound used in (Step 1) include water-soluble compound particles such as lithium hydroxide (LiOH, LiOH.H₂O), lithium carbonate (Li₂CO₃), lithium nitrate, lithium sulfate, lithium acetate, lithium phosphate, lithium dihydrogen phosphate and lithium monohydrogen phosphate.

There are no particular restrictions to a quantitative ratio of the transition metal compound to the lithium compound used in (Step 1), which can be appropriately varied depending on a desired lithium transition metal complex oxide.

### <Additives>

In adding and dispersing a transition metal compound in an aqueous solution of a lithium compound in (Step 1), an organic solvent (for example, polar solvents such as alcohols and aliphatic ketone compounds; aromatic compounds such as xylenes and toluene; and nonpolar solvents such as N-methyl-2-pyrrolidone and dimethyl sulfoxide) can be added to the aqueous solution for wetting the surface of the transition metal compound. A concentration of an organic solvent added is preferably, but not limited to, 0.5% by weight to 10% by weight based on the total weight of the mixture.

Furthermore, to an aqueous solution of a lithium compound can be added a compound such as oxides, hydroxides, fluorides and soluble salts of an element such as Al, Mg, Ca, Ba, Mo, Zr, Ta, Nb and F. By adding these compounds, an element such as Al, Mg, Ca, Ba, Mo, Zr, Ta, Nb and F is complexed with the electrode material, so that the properties of the electrode material are further improved.

Furthermore, a spinel structure lithium-titanium complex oxide, an olivine structure lithium-iron phosphate complex or the like which is less electro conductive can be made electro conductive by adding a carbon material for compositing. Examples of such a carbon material include carbon fiber, carbon black and an organic binding agent.

An apparatus for efficiently providing a mixture in (Step 1) can be, but not limited to, those which can generate shear force or impact force including a stirrer equipped with an impeller, an ultrasonic dispersing device, a homomixer, a mortar, a ball mill, a centrifugal ball mill, a planetary ball mill, a vibratory ball mill, an attritor type high-speed ball mill, a bead mill and a roll mill.

The mixture obtained in (Step 1) preferably has a solid concentration of 10% by weight or more. If a solid concentration is too low, a work load during drying in (Step 2) described later increases, leading to reduction in a production efficiency of the electrode material. Here, a solid concentration refers to a weight concentration of the whole additives present as a solid which is not dissolved in an aqueous lithium solution or an organic solvent for wetting as described above. In terms of a measuring method therefor, a given amount of the mixture obtained in (Step 1) is weighed {A(g)} and then, filtered and dried to give the residual dry material, whose weight is determined {B(g)}. From weights of “A” and “B” determined by these measurement processes, a solid concentration is calculated (solid concentration (%)=B/A×100).

(Step 2) can be conducted using, for example, an apparatus having a rotatory cylinder whose interior is equipped with means for stirring and drying/calcining a mixture with at least one impeller.

It is preferable that the impeller mounted in the interior of the rotatory cylinder has a plurality of blades placed radially at regular intervals, and a tip of at least one of the blades is in contact with the inside surface of the cylinder, allowing the impeller to rotate by the rotation of the cylinder. While the impeller rotates, the mixture in the cylinder is agitated and stirred up by the blade of the impeller, so that adhesion and growth of the mixture on the inside surface of the cylinder is prevented, leading to maintaining good contact with the gas in the rotatory cylinder and heat transfer.

The rotatory cylinder is preferably oblique to a horizontal plane, and the mixture in the cylinder is sequentially fed from the input side to the output side, during which the mixture is dried and calcined. An inclination angle to a horizontal plane is preferably 1° or more and 10° or less. If the inclination angle is too small, a product becomes difficult to be discharged, resulting in difficulty in constant collection. If the inclination angle is too large, a residence time of starting materials in the rotatory cylinder becomes extremely short (less than 2 min), leading to insufficient drying and calcination described later.

In the present invention, a rotation rate of the rotatory cylinder is preferably 5 rpm or more and 40 rpm or less. If the rotation rate is too small, a residence time of the mixture is too short to adequately dry the mixture and also adhesion of the mixture to the inside surface of the cylinder becomes significant. If a rotation rate is too large, the mixture is not effectively stirred.

The blade of the impeller and the rotatory cylinder are preferably made of a material containing, but not limited to, an alloy of nickel or the like as a main component. When nickel is contained as a main component, it is preferably contained in 10% by weight or more and 95% by weight or less.

Preferably, the interior of the above apparatus can be controlled to a predetermined temperature. Although it can be heated using an external or internal heat source, external heating is preferable in the light of controlling an atmosphere of the calcination as described later.

In the present invention, the mixture obtained in (Step 1) is charged in the interior of the above rotatory cylinder. Preferably, the mixture is directly charged in a slurry state, optionally using means for material charging by which the mixture is quantitatively charged into the rotatory cylinder. When the mixture has a low fluidity, it can be charged by means of a screw.

### <Drying and Calcination>

The charged mixture is stirred up, flowed and floated as liquid droplets by an impeller in a heated rotatory cylinder while rapidly being dried/solidified and dehydrated/decomposed on the cylinder surface and in a gas. This dried/solidified mixture is furthermore heated and calcined while being agitated and stirred up in the interior of the rotatory cylinder. The process of the present invention comprising drying and calcining the mixture using a rotatory cylinder equipped with the above impeller has advantages that an adhesion on the inner surface of the rotatory cylinder is eliminated, the mixture is more homogeneously complexing and heating time is reduced in comparison with conventional processes.

A heating temperature of the interior of the rotatory cylinder is preferably, but not limited to, 400° C. or more and less than 1100° C. A temperature during the calcination step is, for example, preferably 700° C. or more and less than 1100° C. in production of a lithium transition metal complex oxide having a layered structure or a spinel structure, and preferably 500° C. or more and less than 700° C. in production of a lithium transition metal complex oxide having an olivine structure. A too low heating temperature leads to uneven drying of the mixture and a too high heating temperature causes formation of an undesired different phase and sintering.

A heating time can be varied depending on an inclination angle of the rotatory cylinder and a rotation rate, and is preferably, but not limited to, 2 min or more and less than 60 min. A too short heating time leads to insufficient crystallization of an electrode material and a too long heating time is not correspondingly effective for crystallization.

### <Atmosphere Gas in the Interior of a Rotatory Cylinder>

An atmosphere gas in the interior of a rotatory cylinder can be prepared from an atmosphere gas fed into the interior, and the above apparatus equipped with a rotatory cylinder may have further means for controlling an atmosphere gas. An atmosphere gas can be appropriately changed such that a desired lithium transition metal complex oxide can be obtained; for example, it is preferable to introduce oxygen gas for producing a layered structure lithium-nickel-cobalt complex oxide, the air for producing a layered structure lithium-nickel-cobalt-manganese complex oxide, an inert gas or a reducing gas such as hydrogen gas and carbon monoxide gas for producing an olivine structure lithium-iron phosphate complex oxide, and the air or an inert gas for producing a spinel structure lithium-titanium complex oxide.

### <Lithium Transition Metal Complex Oxide>

Examples of a lithium transition metal complex oxide which can be produced by the present invention include, but not limited to, layered structure lithium cobalt oxide, lithium nickel oxide, lithium-nickel-cobalt-manganese complex oxide and lithium-nickel-cobalt-aluminum complex oxide; spinel structure lithium manganese oxide and lithium titanium oxide; and olivine structure iron lithium phosphate.

### <Lithium Secondary Battery>

In case that a lithium transition metal complex oxide produced by the maufacturing process of the present invention is used as an electrode material for a lithium secondary battery, the electrolyte of the lithium secondary battery contains a lithium compound as a solute expressing ion conductivity, and a solvent for dissolving and containing the solute can be used as long as it is not decomposed during charge/discharge or storage. Specific examples of a solute include LiClO₄, LiPF₆, LiBF₄, LiCF₃SO₃, LiN(CF₃SO₂)₂ and LiC(CF₃SO₂)₃. Examples of a solvent include cyclic carbonates such as ethylene carbonate (EC), propylene carbonate (PC) and vinylene carbonate (VC); linear carbonates such as dimethyl carbonate (DMC), methyl ethyl carbonate (MEC) and diethyl carbonate (DEC); cyclic ethers such as tetrahydrofuran (THF) and 2-methyltetrahydrofuran (2MeTHF); linear ethers such as dimethoxyethane (DME); y-butyrolactone (BL), acetonitrile (AN), sulfolane (SL) and sultones such as 1,3-propane sultone and 1,3-propene sultone, and these organic solvents can be used alone or as a mixture of two or more. The electrolyte can also be a gelled polymer electrolyte produced by impregnating a polymer electrolyte such as polyethylene oxide and polyacrylonitrile with an electrolytic solution, or an inorganic solid electrolyte such as LiI.

### EXAMPLES

There will be described the present invention with reference to, but not limited to, Examples and Comparative Examples.

Measurement methods in the following examples are as follows.

### <Solid Concentration>

A solid concentration of a mixture was determined as follows. 100 mL of a mixture prepared by dispersing a transition metal compound in a solution of a lithium compound in an aqueous medium was taken, weighed and then filtered. The residue was transferred into a Teflon® beaker and dried at 110° C. for 5 hours. Then, the dried substance was weighed and a weight concentration was calculated from the each weight.

### <Average Particle Size>

An average particle size of a calcined product was quantified using a laser diffraction/scattering type particle size analyzer Microtrac MT3300EXII (Nikkiso Co., Ltd.).

### <Specific Surface Area>

A specific surface area was determined by a BET 1-point continuous method using Macsorb HM-model 1208 (MOUNTECH Co., Ltd.) after drying/degassing a calcined sample at 100° C. for 30 min under a nitrogen gas stream.

### Example 1

A mixture (solid concentration: 41% by weight, Li/Ti molar ratio: 0.82) was prepared by mixing with stirring 29.1% by weight of anatase-type titanium dioxide particles with an average primary particle size of 150 nm [TiO₂: molecular weight 79.8658](Sakai Chemical Industry Co., Ltd., SA-1, average primary particle size: 0.15 μm, specific surface area: 9.7 m²/g), 11.0% by weight of lithium carbonate particles {Li₂CO₃(molecular weight: 73.8909)(Kennametal Inc., 60M, average primary particle size: 5.3 μm, specific surface area: 1.4 m²/g)}, 58.1% by weight of ion-exchange water and 1.8% by weight of ethanol. The mixture was dried and calcined using a rotatory cylinder with an inclination angle of 5° and a rotation rate of 30 rpm (furnace body length: 5 m, furnace tube diameter: 20 cm, impeller: length from the center to a blade tip: 9 cm, 10 blades) under an air stream at 15 L/min from an output side. A heating temperature of the rotatory cylinder was 700° C. in the input side, 850° C. in the center and 850° C. in the output side, and a residence time in the heating part was 7 min. The resulting lithium-titanium complex oxide had an average particle size of 0.35 μm and a specific surface area of 9 m²/g, and showed a single phase of Li₄Ti₅O₁₂ as determined by X⁻ray diffraction crystal structure analysis (XRD).

### Comparative Example 1

Using a mixer (NIPPON COKE & ENGINEERING. CO., LTD., FM mixer), 72.6% by weight of anatase-type titanium dioxide particles and 27.4% by weight of lithium carbonate particles which were used as in Example 1 were mixed with stirring for 30 min. The mixture (Li/Ti molar ratio: 0.82) was charged in an alumina box sagger, which was placed in a muffle furnace and calcined at 850° C. in the atmosphere. A heating was conducted with temperature rise over 90 min, holding at 850° C. for 90 min and cooling over 120 min. The resulting lithium-titanium complex oxide had an average particle size of 0.5 μm and a specific surface area of 3 m²/g, and X-ray diffraction crystal structure analysis (XRD) showed two phases of Li₄Ti₅O₁₂ and anatase-type TiO₂.

### Example 2

A lithium-titanium complex oxide complexed with a fine carbon fiber was produced according to the following procedure, using a rotatory cylinder heater as described in Example and using a fine carbon fiber agglomerate, titanium dioxide particles and lithium hydroxide.

### (1) Preparation of a Fine Carbon Fiber Dispersion

5 parts by weight of an agglomerate of a fine carbon fiber (Ube Industries, Ltd., AMC, specific surface area: 230 m²/g, average outer diameter: 11 nm, average inner diameter: 6 nm, length: from 0.5 μm to 10 μm) was added to an aqueous solution of 1 part by weight of carboxymethylcellulose (Daicel FineChem Ltd., CMC Daicel 1110) in 94 parts by weight of ion-exchange water, and after mixing, the agglomerate was opened using an ultrasonic generator (Nippon Seiki CO., Ltd, Ultrasonic Homogenizer MODEL US-600T) for 40 min and then dispersed to prepare a fine carbon fiber dispersion containing 5% by weight of the fine carbon fiber.

(2) Preparation of a Mixture for Calcination and Production of a Lithium-Titanium Complex Oxide Particle Complexed with a Fine Carbon Fiber

A mixture (solid concentration: 42.9% by weight, Li/Ti molar ratio: 0.82) was prepared by mixing with stirring 12.6% by weight of lithium hydroxide particles (LiOH.H₂O (molecular weight: 41.96362)) (Honjo Chemical Corporation, like coarse granulate), 29.1% by weight of rutile-type titanium dioxide particles (TiO₂ (molecular weight: 79.8658)) (DuPont, R-101, average primary particle size: 0.29 μm), 23.3% by weight of the fine carbon fiber dispersion prepared in (1) described above (fine carbon fiber content: 5% by weight) and 35.0% by weight of ion-exchange water. With an inclination angle of a rotatory cylinder of 2.5° and a rotation rate of 20 rpm, the mixture was charged, dried and calcined under a nitrogen gas stream at 15 L/min. A heating temperature of the rotatory cylinder was 700° C. in the input side, 900° C. in the center and 900° C. in the output side, and a residence time in the heating part was 20 min.

The lithium-titanium complex oxide complexed with the fine carbon fiber as a network obtained above had an average particle size of 0.4 μm and a specific surface area of 14 m²/g, and X-ray diffraction crystal structure analysis (XRD) showed a single phase of Li₄Ti₅O₁₂. The lithium-titanium complex oxide particles composited with the fine carbon fiber was pressurized at 100 kg/cm²G and measured by a DC (direct current) resistance meter, giving a volume resistivity of 3×10¹ Ω·cm.

### Example 3

An iron lithium phosphate complexed with a fine carbon fiber was produced as described below, using a rotatory cylinder heater as used in Example 1 and a fine carbon fiber agglomerate, magnetite particles, lithium carbonate and phosphoric acid.

An aqueous solution of lithium dihydrogen phosphate was prepared by mixing with stirring 21.4% by weight of phosphoric acid (H₃PO₄ molecular weight: 98.00) (Nippon Chemical Industrial Co., Ltd., purity: 85% by weight), 6.86% by weight of lithium carbonate as used in Example 1, and 34.4% by weight of ion-exchange water. To the solution were added 14.3% by weight of magnetite particle (Fe₃O₄ molecular weight: 231.533) (Titan Kogyo Ltd., BL-100, specific surface area: 5.5 m²/g) and 23.0% by weight of a fine carbon fiber dispersion (fine carbon fiber content 5% by weight) prepared in Example 2(1), and the mixture was mixed with stirring to give a mixture (solid content: 22.3% by weight, Li/Fe molar ratio: 1.00, Li/P molar ratio: 1.00). The mixture was charged in a rotatory cylinder (inclination angle: 3°, rotation rate: 30 rpm) under hydrogen gas stream from the output side at 7.5 L/min (about 1.5 fold of a theoretical amount) and then dried and calcined. A heating temperature of the rotatory cylinder was 500° C. in the input side, 600° C. in the center and 600° C. in the output side, and a residence time in the heating part was 15 min.

The iron lithium phosphate complex oxide composited with a fine carbon fiber as a network thus obtained had an average particle size of the aggregate of 2.3 μm and a specific surface area of 13 m²/g, and X-ray diffraction crystal structure analysis (XRD) showed a single phase of iron lithium phosphate. The iron lithium phosphate particles complexed with a fine carbon fiber was pressurized at 100 kg/cm²G, and measured by a DC resistance meter, giving a volume resistivity of 2×10¹ Ω·cm.

### Example 4

Lithium-nickel-cobalt-aluminum complex oxide was produced as described below, using a rotatory cylinder heater as used in Example 1 and using nickel-cobalt hydroxide, aluminum hydroxide and lithium hydroxide as used in Example 2.

A water-soluble mixture (solid concentration: 71.6% by weight, Li/(Ni+Co+Al) molar ratio: 1.05) was prepared by mixing with stirring 47.3% by weight of nickel-cobalt hydroxide (Ni_{0.85}Co_{0.15}(OH)₂ (molecular weight: 92.744405)) (Honjo Chemical Corporation, nickel hydroxide 10 μm type, specific surface area: 6 m²/g, average particle size: 10 μm), 1.21% by weight of aluminum hydroxide particles (Al(OH)₂ (molecular weight: 78.003558)), 23.1% by weight of lithium hydroxide and 28.4% by weight of ion-exchange water. The mixture was charged in a rotatory cylinder (inclination angle: 7°, rotation rate: 30 rpm) under an oxygen gas stream at 15 L/min from the output side, and dried and calcined. A heating temperature of the rotatory cylinder was 600° C. in the input side, 800° C. in the center and 800° C. in the output side, and a residence time in the heating part was 6 min.

The lithium-nickel-cobalt-aluminum complex oxide particles (LiNi_{0.83}Co_{0.14}Al_{0.03}O₂) thus obtained had an average particle size of 10 μm, a specific surface area of 0.3 m²/g, and a bulk density of 1.8 g/mL.

### Comparative Example 2

The mixture prepared in Example 4 was charged in a rotatory cylinder on the same condition as Example 4, except that the rotatory cylinder does not have an impeller. One minute after the charge of the mixture, the mixture was discharged in a slurry state from the outlet of the rotatory cylinder, and drying and calcination did not proceed. Furthermore, a dried substance adhered to the input side in the rotatory cylinder, resulting in making charging of the mixture difficult.

### Example 5

Lithium-nickel-cobalt-manganese complex oxide was produced as described below, using a rotatory cylinder heater as used in Example 1.

A mixture (solid concentration: 72.9% by weight, Li/(Ni+Co+Mn) molar ratio: 1.05) was prepared by mixing with stirring 49.2% by weight of nickel-cobalt-manganese hydroxide (Ni_{1/3}Co_{1/3}Mn_{1/3}(OH)₂ (molecular weight: 91.53623)) (Honjo Chemical Corporation, nickel-cobalt-manganese hydroxide 10 μm type, specific surface area: 7.5 m²/g, average particle size: 11 μm), 23.7% by weight of lithium hydroxide (identical to that used in Example 2) and 27.1% by weight of ion-exchange water. The mixture was charged in a rotatory cylinder (inclination angle: 5°, rotation rate: 30 rpm) under an air stream at 15 L/min from the output side, and dried and calcined. A heating temperature of the rotatory cylinder was 600° C. in the input side, 950° C. in the center and 900° C. in the output side, and a residence time in the heating part was 11 min.

The lithium-nickel-cobalt-manganese complex oxide particles (LiNi_{1/3}Co_{1/3}Mn_{1/3}O₂) had an average particle size of 11 μm, a specific surface area of 0.2 m²/g and a bulk density of 1.7 g/mL.

### Comparative Example 3

A mixture of 67.5% by weight of nickel-cobalt-manganese hydroxide as used in Example 5 and 32.5% by weight of lithium hydroxide was mixed with stirring by a mixer (NIPPON COKE & ENGINEERING. CO., LTD., FM mixer) for 30 min. The mixture (Li/(Ni+Co+Mn) molar ratio: 1.05) was charged in an alumina sagger, which was placed in a muffle furnace and processed in the air with temperature rise over 120 min, holding at 950° C. for 120 min and cooling over 150 min.

The lithium-nickel-cobalt-manganese complex oxide particles (LiNi_{1/3}Co_{1/3}Mn_{1/3}O₂) had an average particle size of 11 μm, a specific surface area of 0.3 m²/g, and a bulk density of 1.6 g/mL.

Using each of the electrode materials obtained in Examples and Comparative Examples as a cathode active material, the electrode material, acetylene black (Denkikagaku Kogyo Kabushiki Kaisha, DENKA BLACK) and polyvinylidene fluoride (PVDF) (Kureha Corporation, KF polymer) were kneaded in N-methylpyrrolidone as a solvent in a weight ratio of 90:5:5 by a kneader to prepare an electrode slurry. The electrode paste was applied to an aluminum mesh substrate, which was then dried under vacuum at 150° C., to produce a cathode plate (15 mm□). Using the cathode plate, a Li plate as a counter electrode and a separator impregnated with an electrolytic solution that is 1 mol/L solution of LiPF₆ in a solvent comprising 1:2 of ethylene carbonate (EC) and dimethyl carbonate (DMC), a coin cell was produced and used as a non-aqueous electrolyte battery for evaluation.

These batteries were evaluated by a charge/discharge test under potential control varying a voltage with a current density of 0.2 mA/cm² for measuring a charge/discharge capacity. The results are shown in Table 1.

TABLE 1

| | Charge/ | Initial | Initial | Charge/ |
|---|---|---|---|---|
| | discharge | charge | discharge | discharge |
| | voltage | capacity | capacity | efficiency |
| | range V | mAh/g | mAh/g | % |
| Example 1 | 1.4 to 2.0 | 171 | 164 | 97 |
| Comparative | 1.4 to 2.0 | 149 | 135 | 91 |
| Example 1 | | | | |
| Example 2 | 1.4 to 2.0 | 167 | 163 | 98 |
| Example 3 | 4.0 to 2.5 | 162 | 146 | 90 |
| Example 4 | 4.3 to 3.0 | 214 | 186 | 87 |
| Example 5 | 4.3 to 3.0 | 175 | 154 | 88 |
| Comparative | 4.3 to 3.0 | 170 | 147 | 86 |
| Example 3 | | | | |

1-10. (canceled)

11. A process for continuously manufacturing a lithium secondary battery electrode material comprising:
dispersing a transition metal compound in a solution of a lithium compound in an aqueous medium to give a mixture; and
charging the mixture in a rotatory cylinder and drying and calcining the mixture;
wherein the mixture is stirred by an impeller mounted in the interior of the rotatory cylinder.

12. The manufacturing process according to claim 11, wherein the impeller mounted in the rotatory cylinder comprises a plurality of blades mounted such that the blades are to be in contact with the inner surface of the rotatory cylinder and rotation of the rotatory cylinder causes rotation of the impeller, making the mixture to be stirred up, flowed and/or floated.

13. The manufacturing process according to claim 11, wherein in the drying and calcining, the mixture is heated at a temperature of 400° C. or more and less than 1100° C. and a heating time is 2 min or more and less than 60 min.

14. The manufacturing process according to claim 11, wherein the rotatory cylinder is oblique to a horizontal plane at an angle of 1° or more and 10° or less.

15. The manufacturing process according to claim 11, wherein a rotation rate of the rotatory cylinder is 5 rpm or more and 40 rpm or less.

16. The manufacturing process according to claim 11, wherein the rotatory cylinder and the impeller are made of an alloy containing 10% by weight or more of nickel as a main component.

17. The manufacturing process according to claim 11, wherein the transition metal compound is selected from the group consisting of hydroxides, oxides, carbonate and oxalates of one or more transition metals.

18. The manufacturing process according to claim 11, wherein a solid concentration in the mixture is 10% by weight or more.

19. The manufacturing process according to claim 11, wherein the mixture comprises a lower alcohol compound or an aliphatic ketone compound.

20. A lithium secondary battery electrode material produced by the manufacturing process according to claim 11, having a layered structure, a spinel structure or an olivine structure.
